(19) United States
(12) Patent Application Publication
(10) Pub. No.: US 2006/0097086 A1
(43) Pub. Date: May 11, 2006

(54) Cavitation-generating attachment

(76) Inventors: Sergiy Zakharchenko, Simferopol (UA); Andrew Fastovsk'yy, Simferopol (UA)

Correspondence Address: Ilya Zborovsky, 6 Schoolhouse Way, Dix Hills, NY, 11746, US

(21) Appl. No.: 11/184,647

(22) Filed: Jul. 19, 2005

(30) Foreign Application Priority Data
Jul. 21, 2004 (UA) 20040706063

(51) Int. Cl. B05B 1/14

(52) U.S. Cl. 239/590; 239/589

(57) ABSTRACT

A hydrodynamic commutation-generating nozzle has a body formed as a nozzle and having a throughgoing passage formed to generate commutation in a medium passing through the passage; and a unit forming an additional chamber located peripherally around the throughgoing passage so as to counteract a pressure of the medium in the passage and confined pieces of the nozzle in the event of its destruction.

### BACKGROUND OF THE INVENTION

The present invention relates to hydrodynamic cavitation-generating attachments for generating a hydrodynamic jet, for example for cleaning surfaces, works with the use of cavitation.

Hydrodynamic cavitation-generating attachments of this type are known in the art. One of such attachments is disclosed for example in RU 2,123,957. The attachment is formed as a nozzle having an inlet passage which includes successively an inlet portion, a substantially cylindrical portion chamber formed as a resonance chamber, and an outlet diffuser portion. This attachment has a disadvantage that of a high pressure and high energy, the attachment can be destroyed and its pieces can injure a user, who for example operates with the attachment under water.

### SUMMARY OF THE INVENTION

It is therefore an object of the present invention to provide a cavitation-generating attachment of this type, which eliminates the disadvantages of the prior art.

In keeping with these objects and with others which will become apparent hereinafter, one feature of the present invention resides, briefly stated, in a cavitation-generating attachment which has a nozzle with an inner passage including inlet and outlet portions, wherein an additional chamber is formed peripherally around at least a part of an axial length of said passage with an inlet from the side of said outlet portion.

When the additional chamber is provided around the inner passage in the cavitation-generating attachment, water entering the additional chamber counteracts an inner pressure created in the inner passage to prevent a destruction of the attachment. In the event if nevertheless a portion of the attachment is destroyed, the pieces of it are confined in said additional chamber.

In accordance with one feature of the present invention, the additional chamber is formed as a peripherally substantially closed annular chamber located at a greater radius than said inner passage.

In accordance with another feature of the present invention, the additional chamber extends over an axial length substantially corresponding to an axial length of an outlet diffuser portion, a cylindrical portion, and an inlet confuse portion.

In accordance with still a further feature of the present invention, the additional chamber is formed by a plurality of openings which are spaced from one another in a circumferential direction.

In accordance with still a further feature of the present invention, the additional chamber is formed in an additional element which is attached to said nozzle and peripherally surrounds it.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing cavitation-generating attachment in accordance with one embodiment of the present invention;

FIG. 2 is a view showing a cross-section of the cavitation-generating attachment of FIG. 1;

FIG. 3 is a view substantially corresponding to the view of FIG. 2, but showing another modification of the cavitation-generating attachment of FIG. 1; and

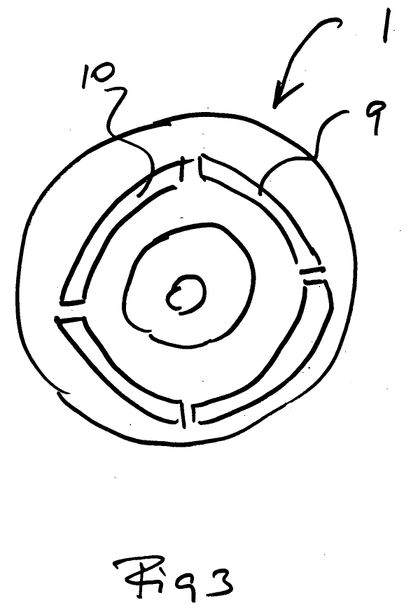

FIG. 4 is a view showing still a further embodiment of the cavitation-generating attachment in accordance with the present invention.

### DESCRIPTION OF THE PREFERRED EMBODIMENTS

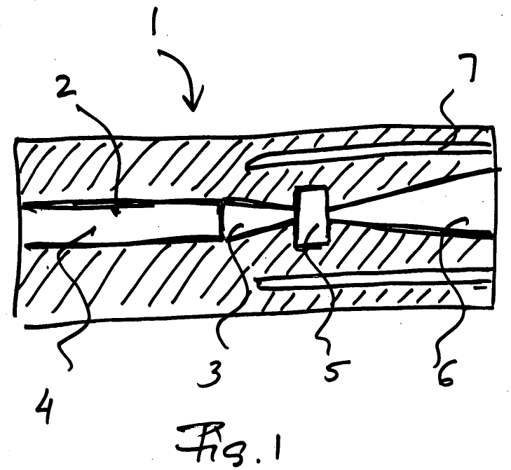

A hydrodynamic cavitation-generating attachment in accordance with the present invention is shown in FIG. 1. It is formed for example as a nozzle which is identified as a whole with reference numeral 1 and is provided with an inner throughgoing passage 2. The throughgoing passage has an inlet portion which can be formed as a confuser portion 3. Another cylindrical portion 4 can be located upstream of the confuser portion 3. A cylindrical portion 5 follows the confuser portion 3. The passage 2 further has a diffuser portion 6 which follows the cylindrical chamber 5.

During the operation of the hydrodynamic cavitation-generating attachment a medium, for example water is introduced into the confuser 3 through the portion 4 and is accelerated so that in the confuser portion 3 bubble formation starts. Then in the cylindrical portion 5 of a greater diameter the number of bubbles in their starting phase increases. Finally, in the diffuser portion 6 the bubbles are fully formed and exit this portion. A flow of the cavitation bubbles pulsates with a frequency depending on the pressure and the speed. When they contact a surface of an object they cause erosion of foreign substances attached to the surface, so that the substances can be removed from the surface. This can be used for cleaning of surfaces.

In accordance with the present invention an additional chamber 7 is provided, which surrounds at least a part of the passage 2. The additional chamber 7 has an inlet at an outlet side of the passage 2, so that medium, for example water can enter the additional chamber 7 from the outlet side. The additional chamber 7 extends over a portion of the length of the nozzle 1, for example over the diffuser 6, the cylindrical chamber 5, and at least a part of the confuser portion 3. When during the operation the medium, for example water is located in the chamber 7 it counteracts an inner pressure of the medium in the passage 2 to prevent a destruction of the nozzle. In the event if nevertheless the destruction occurs, the pieces of the nozzle 2 are confined in the chamber 7.

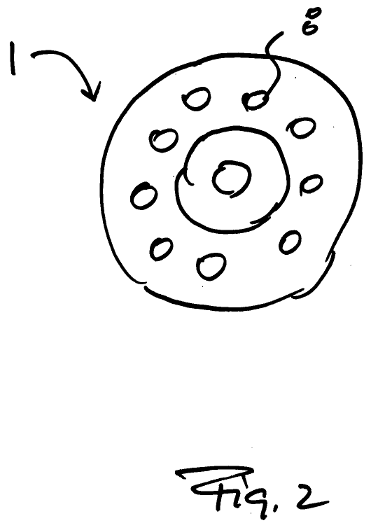

In accordance with one embodiment of the present invention shown in FIG. 2, the chamber 7 is formed by a plurality of blind holes 8 which are located radially outwardly of the portions 6, 5, 3, of the passage 2 and are spaced from one another in a circumferential direction around an axis of the nozzle 2.

In accordance with another embodiment of the present invention, the additional chamber 7 is formed as a substantially uninterrupted circumferential chamber 9 extending circumferentially around the axis of the passage 2 of the nozzle 1. Narrow partitions can remain between the portions of the annular chamber 9 to retain the integrity of the nozzle 1.

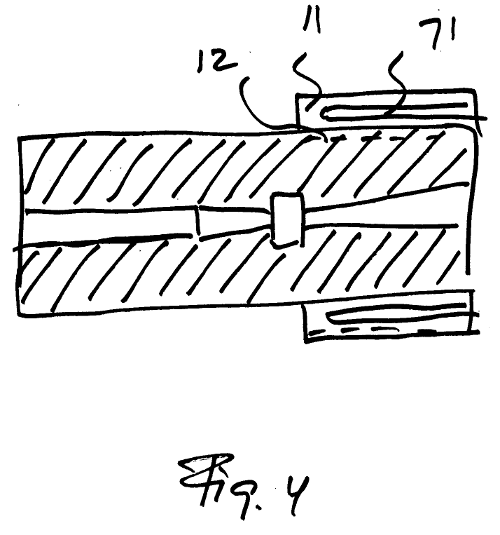

FIG. 4 shows still a further embodiment of the present invention. Here an additional chamber 7′ is substantially similar to the additional chamber 7. However, it is provided in an additional member 11 which is arranged around a part of the nozzle 1. The additional member 11 can be screwed for example on the threaded part of the nozzle 1 by cooperating threads 12. In this embodiment the main part of the nozzle 1 is maintained intact and the additional element is attached to it.

The radial width of the additional chamber can be substantially 2 mm, while the thickness of its outer wall can be substantially 1 mm. It will be understood that each of the elements described above, or two or more together, may also find a useful application in other types of constructions differing from the types described above.

While the invention has been illustrated and described as embodied in a hydrodynamic commutation-generating attachment, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A hydrodynamic commutation-generating nozzle, comprising a body formed as a nozzle and having a throughgoing passage formed to generate commutation in a medium passing through said passage; and means forming an additional chamber located peripherally around said throughgoing passage so as to counteract a pressure of the medium in said passage and confined pieces of the nozzle in the event of its destruction.

2. A hydrodynamic commutation generating nozzle as defined in claim 1, wherein said throughgoing passage includes a confuser portion, a cylindrical portion and a diffuser portion, said additional chamber having an axial length extending substantially over an axial length of said diffuser portion, said substantially cylindrical chamber substantially cylindrical and at least a part of said confuser portion.

3. A hydrodynamic commutation generating nozzle as defined in claim 1, wherein said additional chamber has an inlet located in a region of an outlet of said throughgoing passage.

4. A hydrodynamic commutation generating nozzle as defined in claim 1, wherein said additional chamber is formed by a plurality of holes locating radially outside of said throughgoing passage and spaced from one another in a circumferential direction around said axis.

5. A hydrodynamic commutation generating nozzle as defined in claim 1, wherein said additional chamber is formed as a substantially interrupted annular chamber and sending circumferentially around said axis.

6. A hydrodynamic commutation generating nozzle as defined in claim 1, wherein said additional chamber is formed by an additional member which surrounds at least a part of said nozzle.
